(19) United States
(12) Patent Application Publication
(10) Pub. No.: US 2020/0319027 A1
(43) Pub. Date: Oct. 8, 2020

(54) Spectral Imager System Using a Two Dimensional Filter Array

(71) Applicant: Spectral Sciences, Inc., Burlington, MA (US)

(72) Inventors: Marsha J. Fox, Lexington, MA (US); Steven M. Adler-Golden, Newtonville, MA (US); Neil Goldstein, Belmont, MA (US); Benjamin St. Peter, Burlington, MA (US)

(21) Appl. No.: 16/843,385

(22) Filed: Apr. 8, 2020

Related U.S. Application Data
(60) Provisional application No. 62/830,849, filed on Apr. 8, 2019.

(51) Int. Cl. G01J 3/28; G01J 3/02

(52) U.S. Cl. CPC G01J 3/2823; G01J 3/0297; G01J 3/021; G01J 3/0208

(57) ABSTRACT

A system for acquiring both the spatial and spectral dimensions of a spectral image cube either simultaneously with a single frame acquisition, or sequentially with a small number of frames, using a sensor that uses an array of pixel-size, narrow wavelength bandpass filters placed in close proximity to a focal plane array (FPA), and for processing the acquired data to retrieve spectral image cubes at the pixel resolution of the FPA.

### CROSS-REFERENCE TO RELATED APPLICATION

This application claims priority of Provisional Application 62/830,849 filed on Apr. 8, 2019.

### BACKGROUND

### Field

This disclosure relates to a system for acquiring both the spatial and spectral dimensions of a spectral image cube either simultaneously with a single frame acquisition, or sequentially with a small number of frames, using an array of pixel-size, narrow wavelength bandpass filters placed in close proximity to a focal plane array (FPA), and for processing the acquired data to retrieve spectral image cubes at the pixel resolution of the FPA. The system is designed to provide low size, weight and power consumption (SWAP) in comparison with the prior art.

### Description of the Related Art

Spectral imaging systems, including hyperspectral imaging (HSI) and multispectral imaging (MSI) systems, are commonly deployed on airborne platforms to address a wide variety of remote sensing problems. Thermal Infrared (TIR) spectral imaging sensors, which respond to wavelengths greater than around 3 microns, have the advantage of operating in both daytime and nighttime, providing the ability to classify and identify materials and objects via their unique spectral signatures.

The complexity of typical long wavelength infrared (LWIR) and other TIR optical systems, and in particular the requirement of large cooling subsystems to suppress thermal noise, contribute to very large SWAP (size, weight and power consumption) and have hindered their widespread use. Typical HSI sensors require dispersive prisms or gratings, or a sensitive interferometer, for collection of spectral data, limiting their use to very large platforms with sufficient power sources to cool all of the optical components. Furthermore, a spectral image—i.e., a “data cube” which contains two spatial dimensions and one spectral dimension—typically suffers from artifacts due to frame-to-frame motion jitter, platform motion and target motion. This is because one of the dimensions, either spectral or spatial, is collected sequentially over time, with resulting errors due to small changes in the instantaneous field of view.

“Snapshot” spectral imaging sensors, which simultaneously collect all three cube dimensions, intrinsically eliminate motion artifacts due to multi-frame collection because they produce complete spectra and imagery in a single frame, undistorted by temporal lag. Snapshot sensors are especially advantageous for monitoring dynamic events, such as moving vehicles, gaseous plumes, and combustion transients. The data are obtained at the focal plane array (FPA) frame rate, and can be combined with algorithms for spectral/temporal signature analysis. However, most snapshot spectral imagers are still burdened by bulky optics, such as lenslet arrays or pinhole masks, contributing to SWAP.

In a patent application (International Patent Application No. PCT/US2015/049608) and publication (Kanaev, A. V., M. R. Kutteruf, M. K. Yetzbacher, M. J. Deprenger, and K. M. Novak, “Imaging with Multispectral Mosaic-Array Cameras, Appl. Opt. 54 (31), pp. F149-F157 (2015)), a system is described that uses a short wave infrared mosaic filter array of repeating unit cells. This system is not designed for operation in the TIR and is susceptible to aliasing artifacts due to the repeating cell pattern. Recently, Bierret et al. [2018] (Bierret, A. G. Vincent, J. Jaeek, J.-L. Pelouard, F. Pardo, F. De La Barrière, and R. Haïdar, “Pixel-sized infrared filters for a multispectral focal plane array,” Appl. Opt. 57, 391-395 (2018)) considered pixel-sized filters for the infrared. However, their design is complex due to the use of guided-mode resonance filters incorporating waveguides and gratings.

### SUMMARY

The system of the present disclosure is aimed at eliminating the bulky optics inherent in most snapshot spectral imaging designs by using pixel-size bandpass filters placed directly in front of the focal plane. While up to four such filters, arranged in rectangular groups called superpixels, are used in common visible and visible-near IR cameras, the present disclosure provides larger numbers of filters, corresponding to larger numbers of wavelength bands, such that the spectral signatures of materials may be captured. This disclosure is further aimed at enhancing the signal-to-noise of thermal infrared spectral imagers by allowing the spectrally selective optical elements—namely, the filters—to be efficiently cooled by the focal plane. Another object of this disclosure is to provide spectral image cubes at sub-superpixel spatial resolution using an image reconstruction algorithm, often referred to as an “inpainting” or “demosaicking” algorithm. This allows the use of larger number of bands than would otherwise be practical. Another object of this disclosure is to specify arrangements of the filters within the superpixels that both enhance the reconstruction accuracy and provide the option of directly sampling all wavelength bands at pixel resolution using a sequence of exposures while making small shifts of either the viewed scene or the sensor.

### BRIEF DESCRIPTION OF THE DRAWINGS

Other objects, features and advantages will occur to those skilled in the art from the following detailed description, and the accompanying drawings, in which:

FIG. 1 illustrates a Sudoku-type pattern showing the placement of 36 bandpass filters in a 6×6 array of superpixels.

FIG. 2 illustrates the integration of a filter array in a camera housing.

FIGS. 3A and 3B illustrate Fabry Perot transmission modeled for eight cavity thicknesses producing narrow bands spanning 8 to 13 microns, with arrows indicating desired peaks.

FIG. 4 illustrates the preferred inpainting method.

FIGS. 5A-5D illustrate simulated radiance modeled with 36 filter bandpasses: (a) high-resolution truth at 10 microns, (b) raw 36 channel mosaic, (c) with bilinear interpolation at 10 microns, and (d) with inpainting at 10 microns.

FIG. 6 is a block diagram of a system that uses the sensor and accomplishes the inpainting and other processing methods.

### DETAILED DESCRIPTION

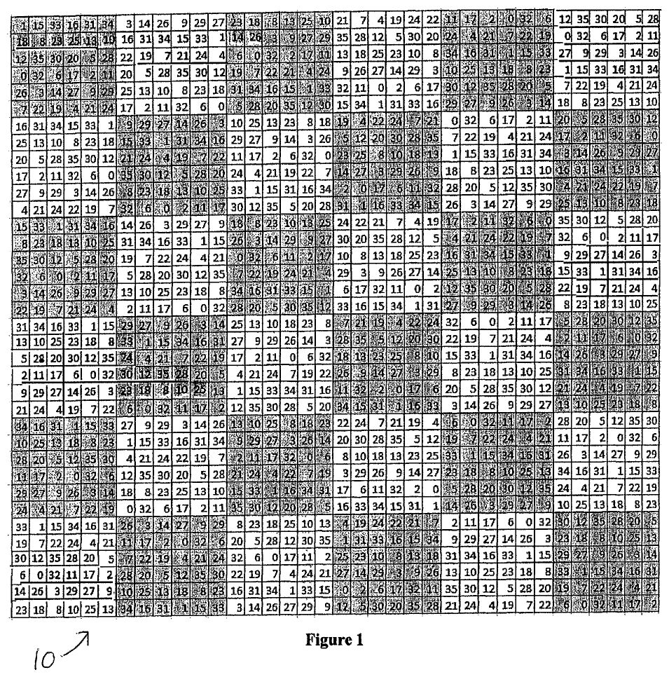

The system and sensor of this disclosure uses a two-dimensional pixelated array of narrow band filters placed directly over the focal plane array (FPA), with each filter pixel co-aligned to a FPA pixel, to collect the image of the scene being viewed. A FPA is an array of light-sensing detectors placed at the focal plane of an imaging system. A subarray of S=n×m filters forms a superpixel, and the S filters span the desired wavelength transmission band. The S filters can have peak transmissions that span a portion of wavelengths of the electro-optical spectrum (the total band). The filter peaks may be spaced uniformly or non-uniformly in wavelength. Each filter may have a full-width-half-maximum (FWHM) transmission band that is much narrower than the total band so that the S filters sample the total band completely at a resolution that is higher than the total band, or they may sparsely sample the total band or they may sample it in a way that favors certain sub-regions of the total band. The FWHM may not be the same for each filter and at least one may be as wide as the total band. The S filters may be randomly arranged within each n×m superpixel, so that no superpixel is like any other, or, in the preferred embodiment, in a Sudoku-type pattern 10, as illustrated in the FIG. 1 example. The exemplary Sudoku-type pattern is an S×S-pixel array constructed from square superpixels (i.e., n=m), such that each filter appears once, and only once, along any row or column.

The image can be processed with an inpainting algorithm to provide spatial resolution at sub-superpixel dimensions. Alternatively, a multiplicity of data frames can be acquired by sequentially shifting the image across the FPA by a multiplicity of pixels, so that a multiplicity of wavelength bands are collected for each spatial resolution element; the frames are then assembled to form a complete data cube.

### DETAILED DESCRIPTION

In the preferred embodiment, the desired wavelength transmission band is the 8-13 micron LWIR band. The S filters are Fabry-Perot etalon filters formed on a single ZnS substrate. A lower mirror, consisting of multiple quarter wave layers, is deposited on the substrate, followed by a thick cavity layer. The cavity layer is etched on pixel scale to depths prescribed to obtain the S transmission responses. An upper mirror is then deposited on the entire substrate to complete the filter. The substrate is antireflection (AR) coated on the reverse side.

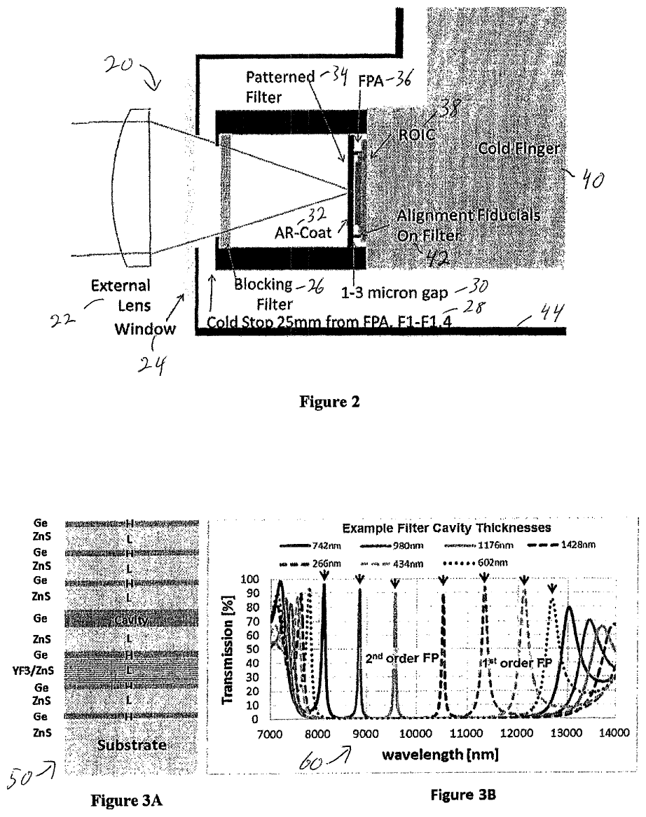

The filter array is mounted as close to the FPA detector elements as possible, ideally within a few microns 30, as illustrated in FIG. 2, to minimize crosstalk from adjacent pixels. The field angle is limited to limit transmission shifts to less than one half of a filter band. An ideal FPA 36 is a thinned back-illuminated or front-illuminated array.

FIG. 2 illustrates one possible layout of a camera housing 20, for an infrared camera, in which the focal plane material 36 is deposited on a read-out integrated circuit (ROIC) 38. In the case of an infrared camera, the camera thermal noise is significantly reduced if the optical elements including the FPA are enclosed in a cryogenically cooled chamber 44, isolated on a mechanical post called a cold finger 40. The cold stop 28 limits the field of view outside the chamber to further reduce thermal noise.

The filter array may include filters that have multiple transmission peaks, where only one peak within the total band is desired to be transmitted. A blocking filter 26 may be included inside the chamber to limit light outside the total band from entering. External lens 22 focuses incoming radiation through window 24. Filter 34 has anti-reflective coating 32. Alignment fiducials 42 assist with proper filter alignment.

An example schematic layering of the Fabry Perot filter deposition 50 is shown in FIG. 3A. Mirrors consist of quarter-wave stacks of alternating high and low index materials. The Ge cavity layer thickness determines the transmission band peak wavelength. The YF3/ZnS stack broadens the lower mirror reflectivity to cover the full 8-13 micron bandpass. FIG. 3B illustrates seven exemplary Fabry Perot filter spectra 60, including the selected filter band and sidebands. Sidebands are blocked using blocking filters and the detector responsivity cutoff. First and second order Fabry Perot transmission bands are used to span the entire wavelength range.

Multispectral mosaic arrays of 3 or 4 pixel superpixels are widely used in RGB and RGB+NIR cameras, with the optical blur diameter matched to the superpixel size. As superpixel size increases, however, the required increased blur diameter and subsequent loss of spatial resolution becomes an obstacle to adoption. Techniques of inpainting or demosaicking have been developed for spectral imaging systems to treat spatial and spectral sparsity (see, e.g., Baone, G. A., “Development of Demosaicking Techniques for Multi-Spectral Imaging Using Mosaic Focal Plane Arrays,” Master's Thesis, University of Tennessee (2005), Chen, Alex, “The inpainting of hyperspectral images: a survey and adaptation to hyperspectral data,” Proc. SPIE 8537, Image and Signal Processing for Remote Sensing XVIII, 85371K (8 Nov. 2012), and Degraux, K., V. Cambareri, L. Jacques, B. Geelen, C. Blanch and G. Lafruit, “Generalized Inpainting Method for Hyperspectral Image Acquisition,” http://arxiv.org/abs/1502.01853 (February 2015)). These techniques assign a full spectrum to each FPA pixel, enabling one to reduce the required optical blur diameter to less than the superpixel dimension, and resulting in recovery of spatial and spectral detail.

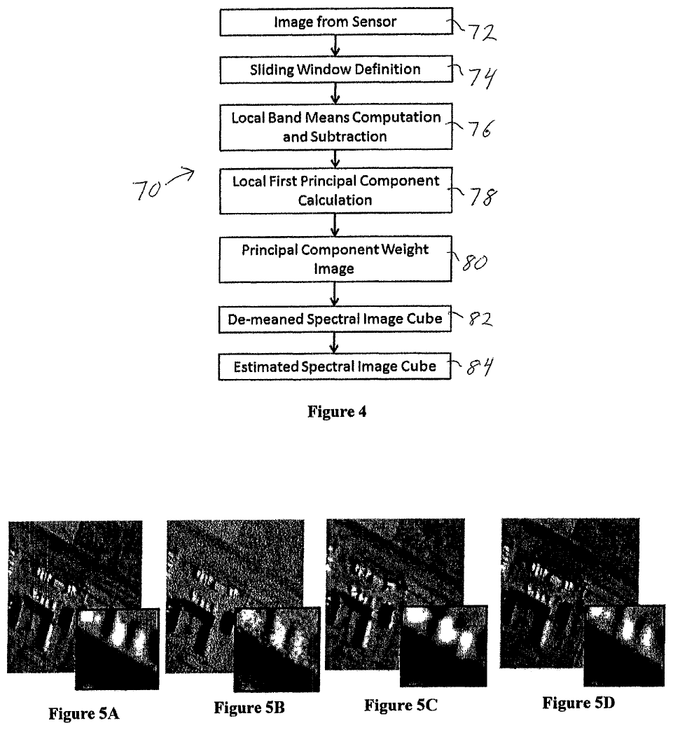

A preferred embodiment method of inpainting 70 that is computationally efficient and provides good results is shown schematically in FIG. 4. The method is based on the principle that very small regions of a spectral image tend to contain just a few distinct materials, and therefore can be described with low spectral dimensionality; the same principle is used in local correlation-based pan-sharpening methods. The preferred embodiment inpainting method constructs a data cube at pixel resolution assuming local one-dimensionality, and consists of the following steps accomplished on captured image data from the sensor 72:
A sliding square window of superpixels 74, such as a 3×3 or 5×5 array, is defined in which mathematical operations denoted as “local” are performed.
Local band means are computed and subtracted from the corresponding pixel values, step 76.
The local first principal component spectrum, denoted PC1, is computed, step 78, from the local de-meaned superpixel spectra within the window using an algorithm such as the Nonlinear Iterative Partial Least Squares algorithm (see, e.g., Wold, H., “Estimation of principal components and related models by iterative least squares,” in Multivariate Analysis (Ed., P. R. Krishnaiah), Academic Press, NY, pp. 391-420 (1966)).
A PC1 weight for each pixel is determined, step 80, as the ratio of the de-meaned pixel value to the PC1 value for that band.
The weighted PC1 spectrum is assigned to each pixel, forming a de-meaned spectral image cube 82.
The local means are then added back to the image, forming a reconstructed (estimated) spectral image cube 84.
An optional local median filter may be applied, in which outlying pixel spectra are replaced with median spectra.

FIGS. 5A-5D demonstrate the preferred embodiment inpainting method with simulated LWIR hyperspectral imagery. The original radiance data are from the SEBASS hyperspectral imager, taken over the DOE Atmospheric Radiation Monitoring site from 1200 feet altitude, and includes detailed structure of buildings and vehicles. A 128×128 region of the data was selected, resampled to 36 narrow bands, and convolved with a Gaussian blur to simulate optical blurring in the sensor. The image for the case of a 3 pixel FWHM diameter blur is shown in FIG. 5a for a 10 micron filter band. A single snapshot is shown in FIG. 5b, with each pixel sensing one narrow band. The organization of filter pixels in each superpixel is random, but includes all 36 bands. From the snapshot a 21×21×36 data cube was formed. The data were then spatially resampled to a 126×126×36 format using bilinear interpolation between pixels of a given spectral band, and also using the preferred embodiment inpainting algorithm. The resulting images for a Fabry Perot filter centered at 10 microns are shown in FIGS. 5c and 5d, respectively. The inset shows detail of vehicles in a parking lot and the edge of a roofline. Comparing the interpolated to the inpainted results, the inpainted image appears less blurred and true to the original.

The use of non-repeating, random positioning of filter bands in each superpixel limits aliasing artifacts in the spectral image reconstruction, regardless of the method. Aliasing artifacts occur when the positions of a given bandpass filter within nearby superpixels are correlated. Aliasing can also be avoided by assigning the filter positions in square superpixels according to the numerical patterns found in Sudoku puzzles. An example is shown in FIG. 1. With Sudoku-type patterns, the filter arrangements are such that each of the S bands occupies exactly one position within each (√S×√S) superpixel and also within each row and column of the S×S pixel array that contains S superpixels.

An advantage of Sudoku-type filter patterns over random patterns is that if a sequence of data frames is acquired in which the scene in view is shifted across the FPA by S or more pixels in either the vertical or horizontal direction, and the scene is effectively static within the acquisition time, then each pixel-level resolution element is sampled at least once by each filter band. Since this shifting method obtains complete spectral and spatial information for the scene, inaccuracies associated with inpainting are avoided. The scene may also be shifted by some number of pixels less than S, in which case each spatial resolution element is sampled by a subset of the S filter bands. With this latter method, a portion of the data values estimated from inpainting may be replaced with direct measurements.

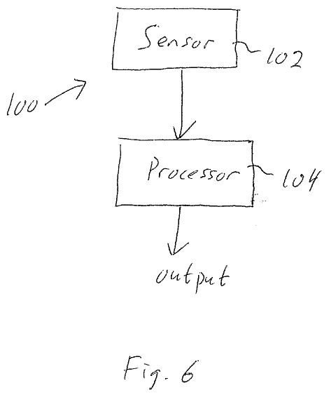

FIG. 6 is a functional block diagram of system 100 with sensor 102 as described above. The sensor image is provided to processor 104, which performs the desired processing, such as the inpainting method described above. Other processing methods are described herein and can be accomplished by processor 104. A processed output is provided.

It will be understood that additional modifications may be made without departing from the scope of the inventive concepts described herein, and, accordingly, other embodiments are within the scope of the following claims.

What is claimed is:

1. An optical sensor, comprising:
a focal plane array (FPA); and
an array of pixel-size, narrow wavelength bandpass filters arranged in rectangular or square groupings called superpixels in front of the FPA, wherein each superpixel comprises N rows and M columns of pixels, wherein the array comprises up to N by M adjacent superpixels, wherein each bandpass occurs once in each superpixel, wherein the arrangements of the filters within the superpixels and the arrangement of the superpixels in an array of adjacent superpixels are such that each bandpass occurs only once in each row and column of the array of adjacent superpixels.

2. The optical sensor of claim 1, wherein the filter array is located within one pixel dimension of the FPA.

3. The optical sensor of claim 1, configured to operate at wavelengths beyond 3 microns.

4. The optical sensor of claim 3, further comprising a system for cooling the FPA to suppress thermal noise.

5. The optical sensor of claim 1, further comprising a processor that is configured to execute a computation method for estimating a sub-superpixel resolution spectral image cube from a single data frame.

6. The optical sensor of claim 5, wherein the computational method comprises the following steps:
a sliding square window of superpixels, such as a 3×3 or 5×5 array, is defined in which mathematical operations denoted as “local” are performed;
local band means are computed and subtracted from the corresponding pixel values;
the local first principal component spectrum, denoted PC1, is computed from the local de-meaned superpixel spectra within the window;
a PC1 weight for each pixel is determined as the ratio of the de-meaned pixel value to the PC1 value for that band;
the weighted PC1 spectrum is assigned to each pixel; and
the local means are added back to the image.

7. The optical sensor of claim 1, further comprising a processor that is configured to execute a method for assembling a sub-superpixel resolution spectral image cube from S or more data frames, where S is the number of wavelength bands, in which the frames are acquired as the scene is sequentially shifted across the FPA to sample the same location with at least S different spectral filters.

8. The optical sensor of claim 7, wherein the method comprises the following steps:
a sliding square window of superpixels, such as a 3×3 or 5×5 array, is defined in which mathematical operations denoted as “local” are performed;
local band means are computed and subtracted from the corresponding pixel values;
the local first principal component spectrum, denoted PC1, is computed from the local de-meaned superpixel spectra within the window;
a PC1 weight for each pixel is determined as the ratio of the de-meaned pixel value to the PC1 value for that band;
the weighted PC1 spectrum is assigned to each pixel; and
the local means are added back to the image.

9. The optical sensor of claim 1, further comprising a processor that is configured to execute a method for assembling a sub-superpixel resolution spectral image cube from a multiplicity of data frames fewer than S, where S is the number of wavelength bands, in which the frames are acquired as the scene is sequentially shifted across the FPA to sample the same location with a multiplicity of spectral filters.

10. The optical sensor of claim 9, wherein the method comprises the following steps:
a sliding square window of superpixels, such as a 3×3 or 5×5 array, is defined in which mathematical operations denoted as “local” are performed;
local band means are computed and subtracted from the corresponding pixel values;
the local first principal component spectrum, denoted PC1, is computed from the local de-meaned superpixel spectra within the window;
a PC1 weight for each pixel is determined as the ratio of the de-meaned pixel value to the PC1 value for that band;
the weighted PC1 spectrum is assigned to each pixel; and
the local means are added back to the image.

11. The optical sensor of claim 1, further comprising a processor that is configured to execute a computation method for estimating a sub-superpixel resolution spectral image cube from the multiplicity of data frames.

12. The optical sensor of claim 11, wherein the computational method comprises the following steps:
a sliding square window of superpixels, such as a 3×3 or 5×5 array, is defined in which mathematical operations denoted as “local” are performed;
local band means are computed and subtracted from the corresponding pixel values;
the local first principal component spectrum, denoted PC1, is computed from the local de-meaned superpixel spectra within the window;
a PC1 weight for each pixel is determined as the ratio of the de-meaned pixel value to the PC1 value for that band;
the weighted PC1 spectrum is assigned to each pixel; and
the local means are added back to the image.

13. The optical sensor of claim 12, wherein the computation method is used to generate initial estimates of the sub-superpixel resolution spectral image cube.

14. A system, comprising:
an optical sensor with an output, the optical sensor comprising:
a focal plane array (FPA); and
an array of pixel-size, narrow wavelength bandpass filters arranged in rectangular or square groupings called superpixels in front of the FPA, wherein each superpixel comprises N rows and M columns of pixels, wherein the array comprises up to N by M adjacent superpixels, wherein each bandpass occurs at least once in each superpixel, wherein the arrangements of the filters within each superpixel is different from any other superpixel or is repeated infrequently, and wherein the filter array is placed within one pixel dimension of the FPA; and
a processor that is configured to process the output of the optical sensor.

15. The system of claim 14 that is configured to operate at wavelengths beyond 3 microns.

16. The system of claim 15, further comprising a system for cooling the FPA to suppress thermal noise.

17. The system of claim 14, wherein the processor is configured to execute a computation method for estimating a sub-superpixel resolution spectral image cube from a single data frame.

18. The system of claim 17, wherein the computational method comprises the following steps:
a sliding square window of superpixels, such as a 3×3 or 5×5 array, is defined in which mathematical operations denoted as “local” are performed;
local band means are computed and subtracted from the corresponding pixel values;
the local first principal component spectrum, denoted PC1, is computed from the local de-meaned superpixel spectra within the window;
a PC1 weight for each pixel is determined as the ratio of the de-meaned pixel value to the PC1 value for that band;
the weighted PC1 spectrum is assigned to each pixel; and
the local means are added back to the image.

19. The system of claim 14, wherein the processor is configured to execute a method for assembling a sub-superpixel resolution spectral image cube from S or more data frames, where S is the number of wavelength bands, in which the frames are acquired as the scene is sequentially shifted across the FPA to sample the same location with at least S different spectral filters.

20. The system of claim 19, wherein the method comprises the following steps:
a sliding square window of superpixels, such as a 3×3 or 5×5 array, is defined in which mathematical operations denoted as “local” are performed;
local band means are computed and subtracted from the corresponding pixel values;
the local first principal component spectrum, denoted PC1, is computed from the local de-meaned superpixel spectra within the window;
a PC1 weight for each pixel is determined as the ratio of the de-meaned pixel value to the PC1 value for that band;
the weighted PC1 spectrum is assigned to each pixel; and
the local means are added back to the image.

21. The system of claim 14, wherein the processor is configured to execute a method for assembling a sub-superpixel resolution spectral image cube from a multiplicity of data frames fewer than S, where S is the number of wavelength bands, in which the frames are acquired as the scene is sequentially shifted across the FPA to sample the same location with a multiplicity of spectral filters.

22. The system of claim 21, wherein the method comprises the following steps:
a sliding square window of superpixels, such as a 3×3 or 5×5 array, is defined in which mathematical operations denoted as “local” are performed;
local band means are computed and subtracted from the corresponding pixel values;
the local first principal component spectrum, denoted PC1, is computed from the local de-meaned superpixel spectra within the window;
a PC1 weight for each pixel is determined as the ratio of the de-meaned pixel value to the PC1 value for that band;
the weighted PC1 spectrum is assigned to each pixel; and
the local means are added back to the image.

23. The system of claim 14, wherein the processor is configured to execute a computation method for estimating a sub-superpixel resolution spectral image cube from the multiplicity of data frames.

24. The system of claim 23, wherein the computational method comprises the following steps:
a sliding square window of superpixels, such as a 3×3 or 5×5 array, is defined in which mathematical operations denoted as “local” are performed;
local band means are computed and subtracted from the corresponding pixel values;
the local first principal component spectrum, denoted PC1, is computed from the local de-meaned superpixel spectra within the window;
a PC1 weight for each pixel is determined as the ratio of the de-meaned pixel value to the PC1 value for that band;
the weighted PC1 spectrum is assigned to each pixel; and
the local means are added back to the image.

25. The system of claim 24, wherein the computation method is used to generate initial estimates of the sub-superpixel resolution spectral image cube.
